(19) United States
(12) Patent Application Publication
(10) Pub. No.: US 2017/0022715 A1
(43) Pub. Date: Jan. 26, 2017

(54) GUTTER CLEANING APPARATUS

(71) Applicant: Charles F. Bohrman, Huntsville, AL (US)

(72) Inventor: Charles F. Bohrman, Huntsville, AL (US)

(21) Appl. No.: 15/219,211

(22) Filed: Jul. 25, 2016

Related U.S. Application Data
(60) Provisional application No. 62/196,663, filed on Jul. 24, 2015.

(51) Int. Cl. E04D 13/076; B08B 9/04; B08B 1/00; A46B 9/02; B25G 3/36

(52) U.S. Cl. CPC E04D 13/0765; A46B 9/026; B25G 3/36; B08B 1/002; B08B 9/04

(57) ABSTRACT

Gutter cleaning apparatus is disclosed. A pair of poles are connected together for a scissors-like action, with an elongated brush holder mounted at one end to the top of each pole and grips at the bottom for a user to hold and manipulate the poles. A pair of brushes configured for fitting within a gutter are mounted in depending relation to the other end of each brush holder so the brushes can be spread apart, lifted over the edge of a gutter and into the gutter to be cleaned. Once inside the gutter the user closes the brushes together, gathering and holding gutter debris that then can be lifted out of the gutter for disposal.

### CROSS REFERENCE TO RELATED APPLICATIONS

This application claims the benefit of Applicant's pending provisional application No. 62/196,663, filed Jul. 24, 2015.

### FIELD OF THE INVENTION

This invention relates to tools for cleaning gutters, and more particularly to a scissors-like device having a pair of brushes or the like at one end for engaging and grasping gutter debris for removal while allowing the user to remain safely on the ground.

### BACKGROUND OF THE INVENTION

Rain downspouts of buildings tend to become clogged due to debris moved by rain into gutters. When the downspouts are clogged, water in the gutters overflow, sometimes between the gutter and facial board or the like to which the gutter is mounted. Over time, the facial board, if made of wood, will become rotted and in need of repair. If made of steel or other metal, the equivalent of the facial board will rust or corrode, again necessitating repair. In addition, when a gutter overflows, water falls where it is not intended, and will typically splash water and mud onto lower portions of exterior walls. Where a building is of wood frame construction, such splashing may eventually damage or cause the exterior wall and possibly the framing to rot or be subject to mold, again nessitating repair. As such, cleaning gutters of buildings is a necessary task.

As gutters are mounted to the edge of a roof, cleaning a gutter typically requires a person to climb a ladder and walk along the edge of the roof, and periodically stoop to physically remove the debris, as with a scoop of some kind, by hand or a combination of both. This is clearly dangerous, as roofs are usually sloped to pass water to the gutter. People have been injured and even killed from falling from a roof while cleaning gutters. According to one study, some 500,000 people suffer ladder accidents each year, with the vast majority of people falling from a height of 12 feet or less.

One known device for accomplishing this is a water-powered nozzle mounted to a pole that a user holds up above the gutter and directs a jet of water therefrom along the length of the gutter to direct the debris in the gutter either to a corner of a roof or to a downspout where the debris is flushed out of the gutter. Problems with this device are that it doesn't itself physically remove debris. Rather, it just washes the debris to a corner where the jet of water might wash the debris over the edge of the gutter, or to a downspout where the water flushes the debris down the downspout. However, it there is a more than a small amount of debris, such as debris from trees, the debris is likely to clog the downspout, requiring the user to further manipulate the water nozzle to dislodge the debris or climb up to the roof to dislodge the debris. In addition, such a process is messy, with the user inevitably being splashed with water and debris from the gutter. Further, the device requires a water hose to supply water, with the length of hose being sufficient to access a gutter around a building. Further yet, the device requires a water hose full of water connected to the water nozzle 10-12 feet or so above the user, or a hollow handle 10-12 feet or so in length with the water hose connected at the bottom. In any case, the user is required to hold and manipulate essentially a water column that may weigh several pounds and cope with reaction forces of a jet of water for an extended period of time while cleaning the gutter, which may be too much of an exertion for some people.

As such, there is an apparent need for a device that will allow someone to clean a gutter from the ground without requiring a user to climb up onto a roof.

### BRIEF DESCRIPTION OF THE DRAWINGS

FIG. 1 is a diagrammatic front view of the invention.

FIG. 2 is a diagrammatic side view of the invention.

FIG. 3 is a diagrammatic front view of another embodiment of the invention.

FIG. 4 is a diagrammatic cross-sectional view of a brush holder of the invention taken along lines 4-4 of FIG. 8.

FIG. 5 is a diagrammatic end view of a pivoting mechanism of the instant invention.

FIG. 6 is a diagrammatic side view of the pivoting mechanism of FIG. 5.

FIG. 7 is a diagrammatic view showing an upper end of poles 10, 14 with attached brush holders 40 and brushes 30, with brushes 30 shown reduced in size.

FIG. 8 is a diagrammatic view of the instant invention in use.

### DETAILED DESCRIPTION OF THE DRAWINGS

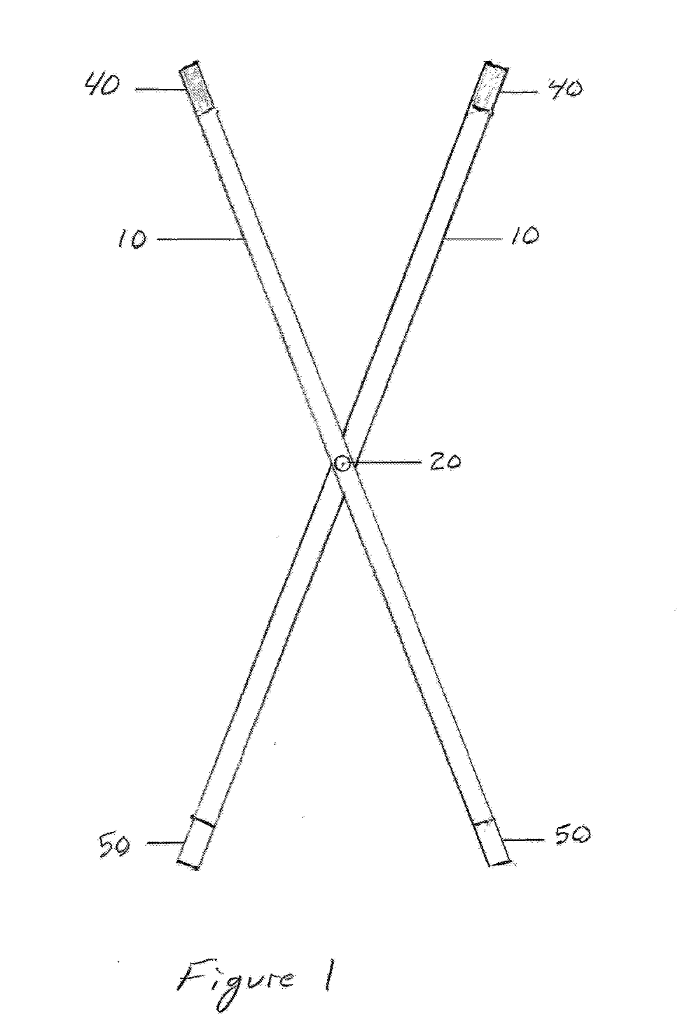

FIG. 1 illustrates the tool of the instant invention as being constructed similar to a large pair of scissors. Two poles or other similar elongated members 10 are pivotally fastened generally at centers thereof by a pivot bolt or other functional equivalent 20. Length of the poles would be sufficient to reach gutters on at least a single story house, or on the order of 4-12 feet or so, with extensions provided as necessary. In some embodiments, telescoping sections that lock together may be provided to adjust a length of the poles. In one embodiment, such locking may be accomplished by a rotating cam at the end of an interior section that locks onto an inner surface of an outer section when the inner section is rotated. In another embodiment, the sections of poles may have one or more holes such that when aligned, a pin is insertable through both the outer and inner section, locking the inner and outer poles together at either a single height or one of several heights. Other embodiments of the poles may be envisioned, such as poles that fold for shipping and storage, as by hinges, and which lock into place for use.

A handle grip 50 is provided for the user at one end of each end of the poles 10 where the poles are grasped by a user in order to manipulate the poles. Poles 10 are opened and closed, i.e. spread apart and brought together, by a user moving the hand grips apart and together in order to catch and remove debris from a gutter.

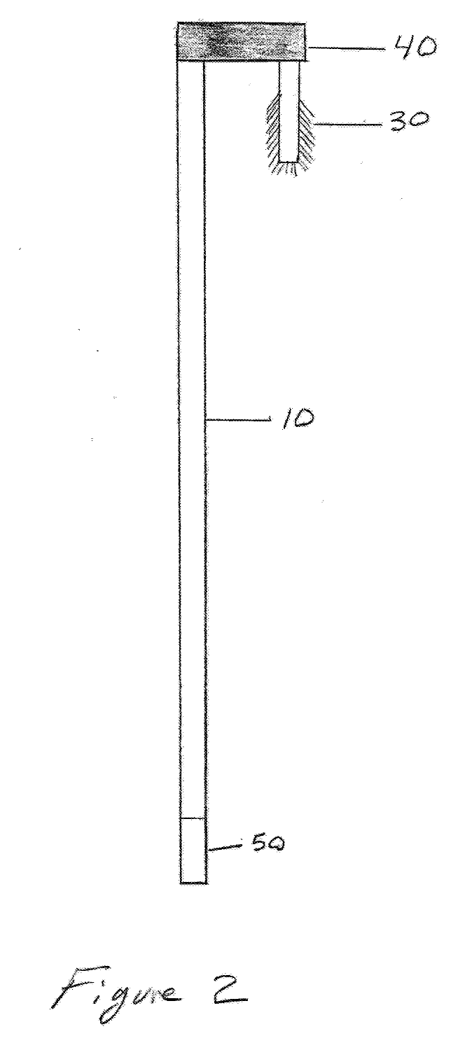

FIG. 2 shows how a brush 30 may be attached to an end of each pole 10 opposite grips 50 by a brush holder 40. In some embodiments, the brush is provided with a threaded member that threadably engages a threaded opening in the brush holder, while in other embodiments the brush holder is provided with a threaded stub shaft onto which a threaded member incorporated in the brush is threaded. Brush holders 40 are mounted so as to provide an offset from poles 10 for brushes to reach over an edge of a gutter and into an interior of the gutter. The brush holders 40 hold respective brushes 30, one for each pole, so that the brushes are oriented generally downward to reach into the gutter. While brushes 30 are shown as being cylindrical, generally elongated brushes, other brush shapes are contemplated, such as round brushes, spherical brushes, paddle-shaped brushes, flat brushes, scoop-shaped brushes and the like. Bristle brush material may be nylon, polypropylene, polyester, polystyrene, PEEK, PTFE or any other suitable brush material, with the bristles having a stiffness sufficient to lift leaves, small branches, and other debris from a gutter. In another embodiment, brushes may be constructed having bristles or a rough surfaces configured for picking up larger debris on one side, and finer bristles for picking up smaller debris on the other side. It is believed a spherical brush would use such a two-sided design effectively, although other brush shapes may benefit from such a two-sided design. For a spherical and other brush shapes, the brush may incorporate a threaded member that may be selectively threaded onto the brush holder such that one side or the other faces the opposed brush having the same selected side. A locking mechanism, such as a cotter or locking pin, may be inserted through openings in the threaded member and brush holder to lock the brush in place on the brush holder for the selected side of use of the brush. In yet another embodiment, scoops may be used instead of brushes to remove heavier, more dense debris, such as where leaves and twigs have become composted in a gutter.

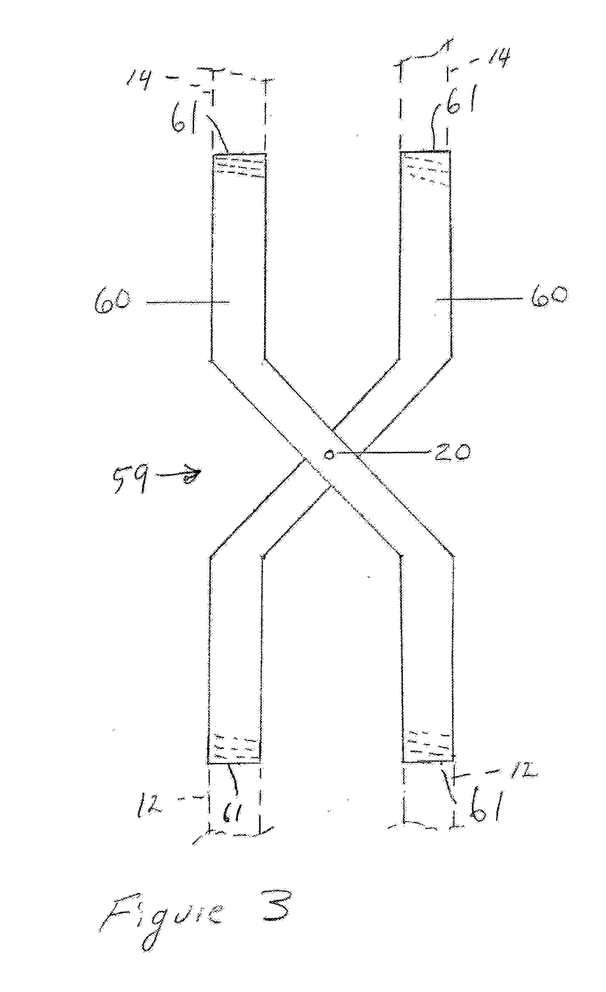

In another embodiment, a center portion 59 may be constructed as shown in FIG. 3. In this embodiment, center portion 59 may be packaged in a kit along with brush holders 40 and brushes 30, and possibly handgrips 50, with the buyer providing lower poles 12 and upper poles 14 (dashed lines). Here, a pair of identical scissors-type members 60 are formed that may have offsets of approximately 45 degrees, although any angle that provided an offset as shown would be workable. In other embodiment, the center section may be constructed of straight sections, such as a straight center section as shown in FIG. 1. A center fastener 20, such as shown in FIG. 1, extending through both members 60 allows pivoting movement of members 60 about fastener 20. Each end of members 60 may be provided with female threads 61 (dashed lines) adapted to receive poles 12, 14, such as readily available threaded poles for mops and the like. As such, four threaded poles 12, 14 provided by the user could be threaded into respective ends of center portion 59. At the other end of the lower poles, handle grips 50 (FIG. 1) may be placed on the poles as described above, and at the other ends of the upper poles brush holders 40 (FIG. 1) and brushes 30 for cleaning gutters are mounted. As noted, the poles may be attached to ends of center portion 59 as by threaded connections at each end of members 60, by bolts or screws extending through openings in the poles and members 60, a friction interference fit or any other way of connection. Such an embodiment is advantageous in that a kit without poles is easier to package and more economical to ship than a package containing long poles. In addition, a user may select a length of the poles as desired. This is advantageous in that a user may select length of the lower poles to be longer than the upper poles in order to provide a mechanical advantage in order to grip debris and remove it from a gutter. Here, any ratio of upper poles to lower poles may be used, such as about 2 feet to three feet for the upper poles and any longer length for the lower poles. For instance, where the upper poles are two feet long and the lower poles are 4 feet long, a user would have twice as much gripping power at the brushes in order to grip and remove gutter debris. This would make the task easier due to not as much force being required to grip the gutter debris.

Cleaning gutters often brings a user to a point where power lines and other service lines enter a building. Accordingly, poles 10 may be constructed of a lightweight and insulative material, such as fiberglass, carbon fiber, dry wood and the like. This would prevent an electrical shock to the user in the event accidental contact with a power or similar line is made. Grips 50 would also be of a non-conductive material.

Brushes 30 may be made having strong, lightweight bristles that are not so stiff that they would scratch paint or surfaces of plastic or aluminum gutters or damage roofing material that overhangs the gutters, but would be sufficiently stiff so as to at least grip leaves and small sticks between the distance of the brushes being fully open to mostly or fully closed. As noted, the bristles could be polyethylene, nylon or other similar materials as noted above. A width of the brushes may typically be about 3 inches or so in order to completely fill the width of gutters being cleaned, and may be of any usable shape to accommodate any particular gutter configuration. Length of the brushes may be about 4″ to 6″ or so in order to easily and fully extend from the brush holder to the bottom and sides of a gutter being cleaned. The brush width may be selected as needed to conform to an interior shape of a gutter. In other embodiments, a portion of the brush holding the bristles may be flexible so that it may be conformed as desired to fit an interior shape of a gutter. Length of the bristles may be about 1″ to 2″ or so in order to provide access to debris under gutter supports. As noted, where the brush is pliable, it may be adjusted angularly with respect to the respective brush holder so that the user may step around bushes or other obstacles on the ground directly below the gutter.

Brush holders 40 may be of Delrin™, Nylon™ polyethylene, polyurethane, wood, lightweight metal such as aluminum, or other similar functional equivalent. The brush holders may be attached or fixed at one end to the end of each pole opposite the handgrips as by a nut and bolt, bonding, a threaded connection or any other known way of attachment. Brushes 30 are attached to the other end of the brush holders, also as by a nut and bolt, a threaded connection or other ways of connection. In some embodiments, an angle of the brush may be adjusted at the brush holder by loosening a fastener holding the brush to the brush holder, adjusting an angle of the brush and then tightening the fastener. This may be accomplished by a ball and clamp arrangement such as found on clamp-on lamp fixtures. As noted, this allows a user to step around obstacles directly below the gutters, and also precludes debris from falling on the user by allowing the user to not be required to stand directly below gutters being cleaned.

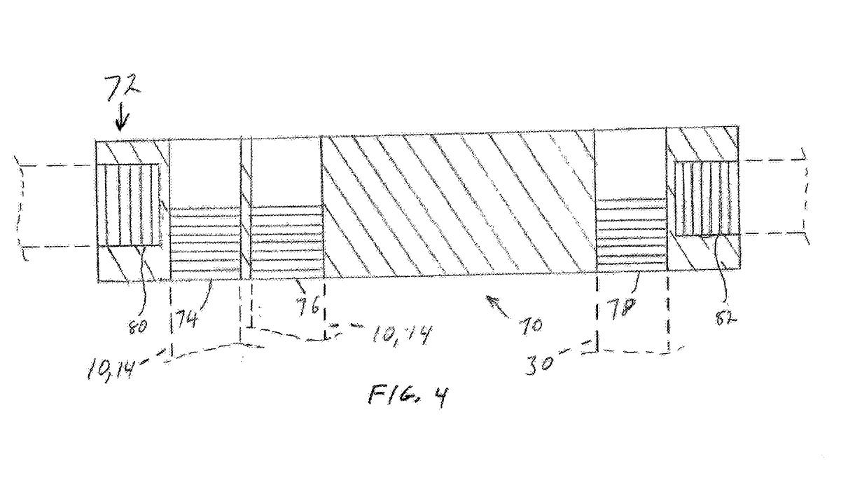

Referring to FIG. 4, one embodiment of a brushholder 70 is shown. In this embodiment, an end 72 of brushholder 70 is provided with two threaded openings 74 and 76, and an opposite end of brushholder 70 is provided with a threaded opening 78. Openings 74, 76 are threaded to receive a threaded end of an upper end of poles 10, 14 above a pivot connection 20, and are offset from each other so that the respective upper poles do not interfere with each other during use. Opening 78 is threaded or otherwise configured to receive a threaded end of a brush 30, which would depend downward so as to be insertable into a gutter. As a feature of this embodiment, ends of brushholder 70 may be provided with threaded openings 80, 82 for use by a user on a roof. Here, such a user on a roof would configure the device so that upper ends of the poles above connection 20 would be attached to one end, such as end 80 of respective brushholders 70, with the respective brushes attached to the opposite respective ends 82. In this embodiment the poles may be somewhat shorter than poles used by a user on the ground. As such, the brushes would be inline or coaxial with at least the upper poles. A user on a roof cleaning gutters would use the device by standing back from the gutters and edge of the roof a distance equal approximately to the length of the poles, and insert the brushes into the gutters in a spread-apart configuration. The brushes are then brought together as described, grasping the gutter debris, and lifted over the edge and opened to release the gutter debris to the ground or into a receptacle. Safety of this embodiment for a roof user is enhanced due to the fact that stooping to clean a gutter near a roof edge is eliminated, as is walking along a roof edge. Thus, the brushholder of FIG. 4 may be used either by a user on the ground or a user on a roof.

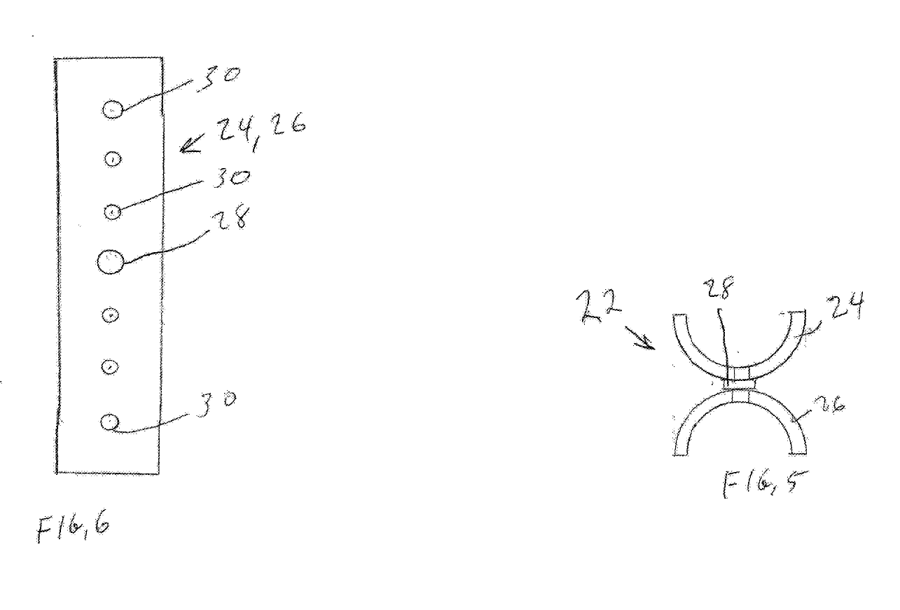

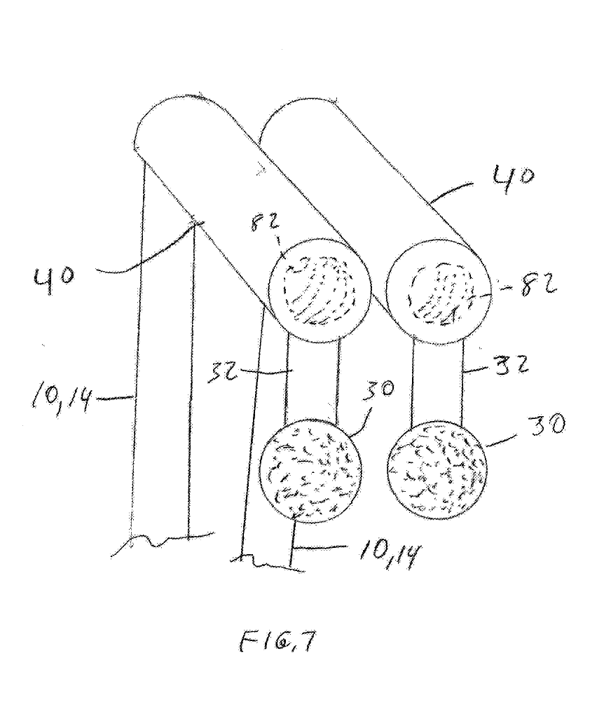

FIG. 5 shows a center pivot 22 configured to receive a round pole, such as a threaded mop handle that may be purchased separately at many retail hardware stores. Here, center pivot 22 has two portions of a hemispherical configuration so as to partially fit around a cylindrical portion of a round pole such as a mop handle. As such, portion 24 would be attached to one pole and portion 26 would be attached to a second pole. The two portions 24, 26 are pivotally attached together by a rotating connection 28, such as a pin, bolt, rivet or the like. As shown in FIG. 6, portions 24, 26 are elongated and provided with openings 30 through which fasteners, such as wood screws, are inserted in order to fasten portions 24, 26 to a respective pole. A washer 28, which may be a nylon or other plastic washer, may be used between portions 24, 26 to provide a small gap between the poles to prevent binding or abrasion between the poles.

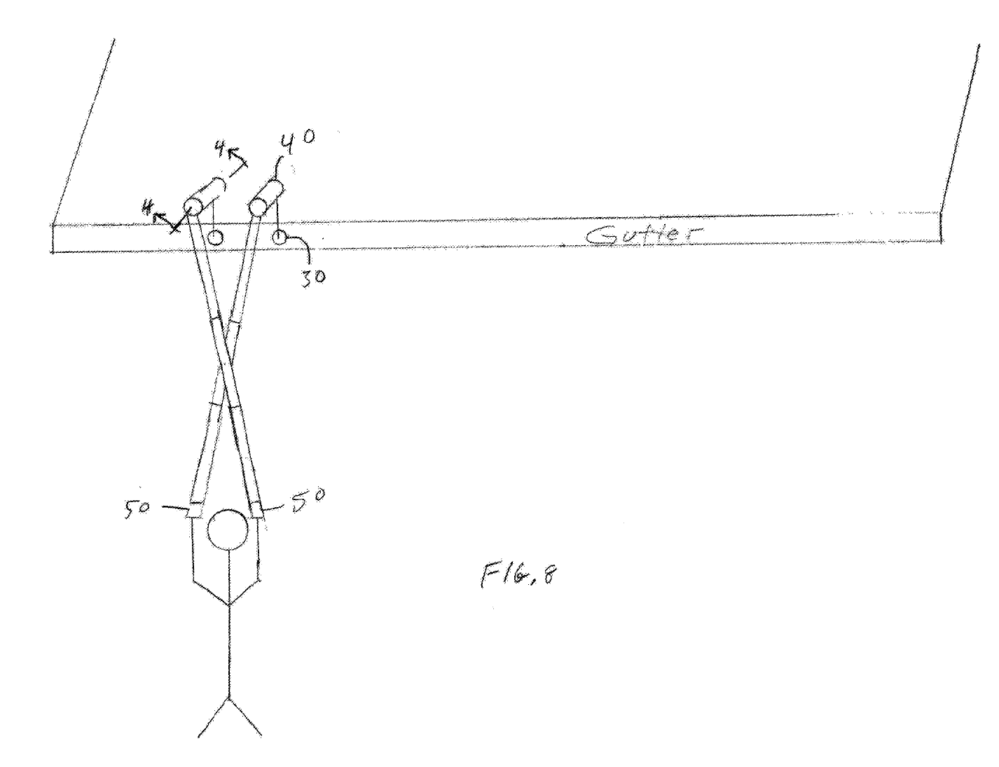

FIG. 7 shows an upper end of the gutter cleaning apparatus with brushes 30 (not drawn to proportion) in a closed configuration to grip gutter debris for removal. As shown in FIG. 4, brushes 30 each may have a threaded shaft 32 that threads into an opening 78 (FIG. 4) for securing the brushes to brush holders 40. Handles 10, 14 may screw into openings 74, 76 (FIG. 4) to hold the brush holders generally perpendicular to handles 10, 14 for use by a user on the ground, or the brushes and handles may be threaded into openings 80, 82 (where provided) for threadably engaging shorter handles for use by a person on a roof.

In use, and as diagrammatically shown in FIG. 8, the user grips handgrips 50 and opens the poles to about shoulder width. Typically, this might be about 2 feet of so. As one feature of the invention, the distance between the brushes may be about the same as the distance between the two grips due to connection 20 being at about the middle of two longer poles (FIG. 1) or the length of the upper and lower poles being about the same length (FIG. 3). This allows more debris to be removed at once by spreading the grips, and thus the brushes, further apart. Where there is a large amount of debris in the gutter, the brushes could be spread apart a shorter distance so the debris would clear roofing material overhanging the gutters. After the brushes are spread an appropriate distance for the amount of debris present, they are brought together by bringing the grips together as shown in FIG. 7, and the brushes holding the debris lifted up and over the gutter after which the grips are spread apart to release the debris. Surprisingly, it has been found that brushes are remarkably effective at removing virtually all debris from gutters.

This lightweight design allows cleaning of gutters without a user having to get on a roof to clean the gutters. In addition, a distance the brushes are spread apart can be selected by the user in order to appropriately remove the amount of debris present. Where there is a lot of debris, the brushes may be spread apart a shorter distance. Where there is less debris, the poles may conceivably be spread apart a distance almost equal to the span of extended arms of a user. As noted, a selectable mechanical advantage may be provided by making the upper poles shorter than the lower poles.

While specific embodiments are described, it should be apparent that modifications may be made that fall within the scope of the invention. For instance, a center connector and brushholders may be configured to be attached to a pole having a rectangular or square cross section. As such, and as noted, a kit may be provided with just the pivoting center connector, brushholders and brushes. A user may cut a 2×4 stud or the like into 1×1 or 2×2 poles using a table saw or rotary hand saw and attach the poles to the center connector and brushholders. Handgrips or handgrip tape may be provided for the lower ends of the poles. As noted, the center connector may be mounted generally at the center of the respective poles, or nearer to the upper end of the poles to provide a mechanical advantage for the user. Further, the disclosed individual elements of the invention may be used in any combination to achieve the desired result.

Having thus described my invention and the manner of its use, it should be apparent to those skilled in the relevant arts that incidental changes may be made thereto that fairly fall within the scope of the following appended claims, wherein I claim:

1. A gutter cleaning apparatus comprising:
a pair of elongated members pivotally attached generally at respective center regions thereof,
a gutter cleaner at one end of said pair of elongated members.

2. A gutter cleaner as set forth in claim 1 further comprising handgrips on said elongated members at an opposite end of said elongated members.

3. A method for cleaning gutters comprising:
sizing a pair of brushes to fill a width and height of a gutter,
placing said brushes in said gutter a selected distance apart, with debris to be removed between said brushes,
moving said brushes toward each other to scrape together and grasp said debris,
removing said brushes with said debris therebetween from said gutter.

4. The method of claim 3 further comprising moving said brushes in said gutters from a ground level.
